(19) United States
(12) Patent Application Publication
(10) Pub. No.: US 2010/0225581 A1
(43) Pub. Date: Sep. 9, 2010

(54) OPTICAL POSITION DETECTING DEVICE, DISPLAY DEVICE WITH POSITION DETECTING FUNCTION, AND ELECTRONIC APPARATUS

(75) Inventor: Kanechika KIYOSE, Matsumoto-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: EPSON IMAGING DEVICES CORPORATION, Nagano (JP)

(21) Appl. No.: 12/715,422

(22) Filed: Mar. 2, 2010

(30) Foreign Application Priority Data
Mar. 4, 2009 (JP) 2009-050287

(51) Int. Cl. G06F 3/033

(52) U.S. Cl. 345/157

(57) ABSTRACT

An optical position detecting device for optically detecting a position of a target object within a detection region, includes: a position detecting light source which emits position detecting light; a position detecting light source driving circuit which drives the position detecting light source; a light detector of which a light receiving portion faces the detection region; and a signal processing unit which creates an environment light intensity determining signal corresponding to intensity of environment light within the detection region and a position detecting signal for detecting the position of the target object within the detection region on the basis of a detecting signal of the light detector.

### BACKGROUND

1. Technical Field

The present invention relates to an optical position detecting device, a display device with a position detecting function and the optical position detecting device, and an electronic apparatus having the display device with the position detecting function.

2. Related Art

Recently, in electronic apparatuses such as a cellular phone, a car navigation device, a personal computer, a ticket vending machine, and a bank terminal, a display device has been used in which a touch panel is disposed on a front surface of an image creating device such as a liquid crystal device and an information input is performed by referring to an image displayed on the image creating device. The touch panel is provided as a position detecting device which detects a position of a target object within a detection region.

In the image creating device, it is necessary to create an image having a high luminance under a bright environment having strong intensity of environment light such as light of fluorescent lamp or solar light, but it is possible to sufficiently see an image without creating an image having a high luminance under a dark environment having weak intensity of the environment light. Therefore, a technology is proposed in which a light receiving element is provided in an electric optical panel to detect the intensity of the environment light and a luminance of an image is controlled on the basis of the detection result (refer to JP-A-2003-78838 and JP-A-2006-118965).

However, in the configurations disclosed in JP-A-2003-78838 and JP-A-2006-118965, since the light receiving element exclusively used for detecting the environment light is provided, it is necessary to change a design of the image creating device so that the environment light is incident to the light receiving element. In addition, when the light receiving element exclusively used for detecting the environment light is provided in a pixel, a light emitting region of display light in the pixel becomes narrow as much as a space used to provide the light receiving element, which causes a problem that a bright display cannot be performed.

### SUMMARY

An advantage of some aspects of the invention is that it provides an optical position detecting device capable of detecting intensity of environment light without providing a light receiving element exclusively used for detecting environment light, a display device with a position detecting function and the optical position detecting device, and an electronic apparatus having the display device with the position detecting function.

According to an aspect of the invention, there is provided an optical position detecting device for optically detecting a position of a target object within a detection region, including: a position detecting light source which emits position detecting light; a position detecting light source driving circuit which drives the position detecting light source; a light detector of which a light receiving portion faces the detection region; and a signal processing unit which creates an environment light intensity determining signal corresponding to intensity of environment light within the detection region and a position detecting signal for detecting the position of the target object within the detection region on the basis of a detecting signal of the light detector.

In the optical position detecting device, the signal processing unit creates the environment light intensity determining signal corresponding to the intensity of the environment light and the position detecting signal for detecting the position of the target object within the detection region on the basis of a detecting signal of the light detector. That is, since the light detector is used to detect the position of the target object and the environment light, it is not necessary to provide the light receiving element exclusively used for detecting the environment light. For this reason, in the case where a display device with a position detecting function is constituted by the combination of an image creating device and the optical position detecting device according to the aspect, even when the light receiving element for detecting the environment light is not provided in the image creating device, it is possible to perform an appropriate image display corresponding to the intensity of the environment light in such a manner that a luminance of an image is automatically controlled in association with the intensity of the environment light.

The optical position detecting device further includes a light guiding plate which includes a light incident surface for receiving therein the position detecting light emitted from the position detecting light source and a light emitting surface for emitting the position detecting light incident from the light incident surface, wherein the light receiving portion of the light detector may face the detection region on the side where the position detecting light is emitted from the light guiding plate. With such a configuration, when the position detecting light is emitted from the light emitting surface of the light guiding plate and is reflected by the target object disposed on the light emitting side of the light guiding plate, the reflected light is detected by the light detector. Here, an attenuation rate until the position detecting light is propagated into the light guiding plate and is emitted therefrom is different at each position. Accordingly, it is possible to detect the position of the target object on the basis of the detection result of the light detector. Therefore, since it is not necessary to dispose plural optical elements along the detection region, it is possible to form the position detecting device at a low cost.

In the optical position detecting device, the light detector may perform a photoelectric conversion on light of a wavelength range from an infrared light range to a visible light range. With such a configuration, it is also possible to detect the intensity of the environment light not including infrared light, for example, light of a fluorescent lamp.

In the optical position detecting device, the signal processing unit may include a position detecting signal extracting section which extracts the position detecting signal from a detection result of the light detector, and the signal processing unit may use a detecting signal of the light detector, obtained before the position detecting signal is extracted by the position detecting signal extracting section, as the environment light intensity determining signal. With such a configuration, it is possible to obtain the position detecting signal without the influence of the intensity of the environment light.

In the optical position detecting device, a first position detecting light source emitting first position detecting light and a second position detecting light source emitting second position detecting light may be provided as the position detecting light source. With such a configuration, on the basis of a light amount ratio, a phase difference, or the like of detection results obtained by the first and second position detecting light sources, it is possible to accurately detect the moving position of the target object in a direction in which the first position detecting light source and the second position detecting light source move away from each other.

In the optical position detecting device, the position detecting light source driving circuit may drive the first position detecting light source and the second position detecting light source so as to have a reverse phase, and the signal processing unit may include a light emitting intensity compensation command section which controls light emitting intensity of one of the first position detecting light source and the second position detecting light source so that light receiving intensity of the light detector for the first position detecting light is equal to light receiving intensity of the light detector for the second position detecting light.

In the optical position detecting device, the position detecting light source may include two pairs of light sources each having the first position detecting light source and the second position detecting light source, and light emitting surfaces for emitting the position detecting light of each pair of light sources may be disposed so as to face each other. With such a configuration, on the basis of a light amount ratio, a phase difference, or the like of the detection results obtained by the first and second position detecting light sources of one pair of light sources, it is possible to detect the moving position of the target object in a direction in which the first and second position detecting light sources of one pair of light sources move away from each other. In addition, on the basis of a light amount ratio, a phase difference, or the like of the detection results obtained by the first and second position detecting light sources of the other pair of light sources, it is possible to detect the moving position of the target object in a direction in which the first and second position detecting light sources of the other pair of light sources move away from each other.

The optical position detecting device according to the aspect of the invention may constitute a display device with a position detecting function by the combination with an image creating device. In this case, the image creating device includes an electric optical panel which is disposed to face the light guiding plate so that the position detecting region overlaps with the image display region.

The display device with the position detecting function may further include a display condition correction command section which changes a display condition of the image creating device in association with intensity of environment light on the basis of the environment light intensity determining signal. For example, in the case where the image creating device includes an liquid crystal panel as the electric optical panel and an illumination device for supplying light to the liquid crystal panel, the display condition correction command section may change light emitting intensity of illumination light from the illumination device or a level of an image signal supplied to the electric optical panel in association with the intensity of the environment light on the basis of the environment light intensity determining signal. In addition, in the case where an organic electroluminescence panel is provided as the electric optical panel in the image creating device, the display condition correction command section may change the level of the image signal supplied to the electric optical panel in association with the intensity of the environment light on the basis of the environment light intensity determining signal.

The display device with the position detecting function according to the aspect of the invention is used in electronic apparatuses such as a cellular phone, a car navigation device, a personal computer, a ticket vending machine, and a bank terminal.

### BRIEF DESCRIPTION OF THE DRAWINGS

The invention will be described with reference to the accompanying drawings, wherein like numbers reference like elements.

FIG. 1 is an exploded perspective view schematically illustrating a configuration of a display device with a position detecting function and an optical position detecting device according to the invention.

FIG. 2A is a sectional view schematically illustrating a sectional configuration of the display device with the position detecting function and the optical position detecting device according to the invention, FIG. 2B is an explanatory diagram illustrating an attenuation state of position detecting light inside a light guiding plate, and FIG. 2C is an explanatory diagram illustrating a state inside the light guiding plate under a condition that there is environment light.

FIG. 3A is an explanatory diagram of a signal processing unit of the display device with the position detecting function and the optical position detecting device according to the invention, and FIG. 3B is an explanatory diagram illustrating process contents of a light emitting intensity compensation command section of the signal processing unit.

FIGS. 4A and 4B are explanatory diagrams illustrating a signal change when environment light is incident to a light detector in the display device with the position detecting function and the optical position detecting device according to the invention.

FIGS. 5A, 5B, and 5C are explanatory diagrams of an electronic apparatus using the display device with the position detecting function according to the invention.

### DESCRIPTION OF EXEMPLARY EMBODIMENTS

Next, an exemplary embodiment of the invention will be described in detail with reference to the accompanying drawings.

### Entire Configuration

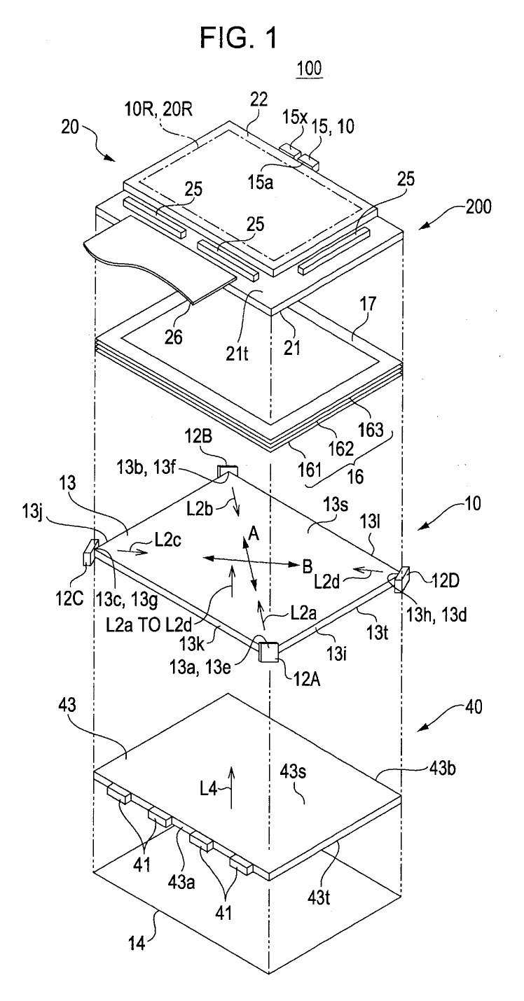

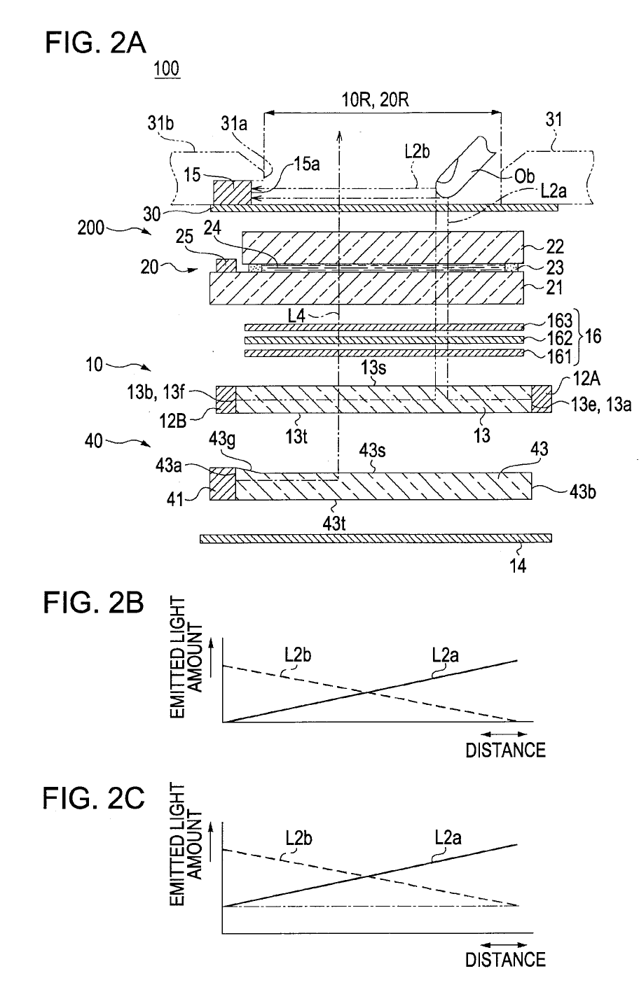

FIG. 1 is an exploded perspective view schematically illustrating a configuration of a display device with a position detecting function and an optical position detecting device according to the invention. FIG. 2A is a sectional view schematically illustrating a sectional configuration of the display device with the position detecting function and the optical position detecting device according to the invention, FIG. 2B is an explanatory diagram illustrating an attenuation state of position detecting light inside a light guiding plate, and FIG. 2C is an explanatory diagram illustrating a state inside the light guiding plate under a condition that there is environment light.

In FIGS. 1 and 2A, a display device 100 with a position detecting function according to the embodiment includes an optical position detecting device 10 and an image creating device 200. The optical position detecting device 10 detects a planar position of a target object Ob when the target object Ob such as a finger moves close to a detection region 10R on the basis of, for example, an image displayed by the image creating device 200.

The optical position detecting device 10 includes position detecting light sources 12A to 12D which emit position detecting light L2a to L2d, a light guiding plate 13 which includes light incident portions 13a to 13d formed on the peripheral end surface portions thereof so as to allow the position detecting light L2a to L2d to be incident thereto, and a light detector 15 which is disposed to face a light receiving portion 15a in the detection region 10R. The light guiding plate 13 includes a light emitting surface 13s which is formed on one surface (in the drawing, the front surface) so as to emit the position detecting light L2a to L2d propagated thereinto. The position detecting light sources 12A to 12D are disposed so as to face the light incident portions 13a to 13d, and are desirably disposed so as to be close to the light incident portions 13a to 13d. In the embodiment, in addition to the light detector 15, a compensation light detector 15x is also used. The compensation light detector 15x is used to compensate an influence of a temperature or the like with respect to a detection result of the light detector 15, but is not used to detect the position detecting light L2a to L2d.

The light guiding plate 13 is formed from a transparent resin plate such as polycarbonate or acrylic resin. In the light guiding plate 13, the light emitting surface 13s or the rear surface 13t on the opposite side of the light emitting surface 13s is provided with a surface unevenness structure, a prism structure, a scattering layer (not shown), and the like. With such a light scattering structure, light being incident from the light incident portions 13a to 13d and propagated into the light guiding plate is gradually deflected as it moves in the propagation direction thereof, and is emitted from the light emitting surface 13s. A reflection plate 14 constituted by a reflection sheet or the like is disposed in rear of the light guiding plate 13, and the reflection plate 14 serves to return the position detecting light L2a to L2d, emitted from the rear surface 13t of the light guiding plate 13, into the light guiding plate 13.

In the embodiment, the light guiding plate 13 has a substantially square-like planar shape having four side portions 13i to 13l, and four corner portions 13e to 13h thereof are respectively formed as the light incident portions 13a to 13d. Here, the light incident portions 13a to 13d are formed as, for example, end surfaces formed by removing the corner portions 13e to 13h of the light guiding plate 13.

For example, each of the position detecting light sources 12A to 12D is formed as a light emitting element such as an LED (light emitting diode), and emits the position detecting light L2a to L2d formed by infrared light in response to a driving signal output from a driving circuit (not shown). The type of the position detecting light L2a to L2d is not particularly limited, but it is desirable that the position detecting light is distinguished from external light by a signal process or the like to be described later, and it is desirable that the position detecting light has a wavelength distribution different from that of visible light or has a different light emission type by adding a modulation such as flickering. In addition, it is desirable that each of the position detecting light L2a to L2d has a wavelength range in which the light is efficiently reflected by the target object Ob such as a finger or a touch pen. For example, when the target object Ob is a human body such as a finger, infrared light (particularly, near infrared light close to a visible light range, for example, in the vicinity of 850 nm of wavelength) having high reflectivity with respect to a surface of the human body is desirable.

A plurality of the position detecting power sources 12A to 12D is provided, and is configured to emit the position detecting light at different positions. In the embodiment, among four position detecting light sources 12A to 12D, two arbitrary position detecting light sources make a pair to thereby constitute a pair of first light sources and the other two position detecting light sources make a pair to thereby constitute a pair of second light sources. In the embodiment, the position detecting light sources 12A and 12B disposed at the diagonal positions of the light guiding plate 13 constitute the pair of first light sources, and the other two position detecting light sources 12C and 12D constitute the pair of second light sources. In this case, in the pair of first light sources, one of the two position detecting light sources 12A and 12B is used as a first position detecting light source, and the other thereof is used as a second position detecting light source. Accordingly, in the pair of first light sources, the position detecting light source L2a corresponds to first position detecting light, and the position detecting light L2b corresponds to second position detecting light. In addition, one of the light incident portions 13a and 13b of the light guiding plate 13 corresponds to a first light incident portion, and the other thereof corresponds to a second light incident portion. For this reason, in the pair of first light sources, the first position detecting light source 12A and the second position detecting light source 12B face each other with the light guiding plate 13 interposed therebetween.

In addition, in the pair of second light sources, one of the two position detecting light sources 12C and 12D is used as the first position detecting light source, and the other thereof is used as the second position detecting light source. Accordingly, in the pair of second light sources, the position detecting light L2c corresponds to the first position detecting light, and the position detecting light L2d corresponds to the second position detecting light. In addition, one of the light incident portions 13c and 13d of the light guiding plate 13 corresponds to the first light incident portion, and the other thereof corresponds to the second light incident portion. For this reason, in the pair of second light sources, the first position detecting light source 12C and the second position detecting light source 12D face each other with the light guiding plate 13 interposed therebetween.

In the display device 100 with the position detecting function having such a configuration, the central optical axis of the pair of first light sources intersects the central optical axis of the pair of second light sources. For this reason, the first position detecting light L2a and the second position detecting light L2b is propagated in the opposite directions in the direction depicted by the arrow A in the inside of the light guiding plate 13, and is gradually emitted from the light emitting surface 13s along the propagation direction. On the contrary, the first position detecting light L2c and the second position detecting light L2d is propagated in the opposite directions in the direction (depicted by the arrow B) intersecting the direction depicted by the arrow A, and is gradually emitted from the light emitting surface 13s along the propagation direction.

In the display device 100 with the position detecting function according to the embodiment, if necessary, the light emitting side of the light guiding plate 13 is provided with an optical sheet 16 which is used to equalize the position detecting light L2a to L2d. In the embodiment, as the optical sheet 16, there are used a first prism sheet 161 which faces the light emitting surface 13s of the light guiding plate 13, a second prism sheet 162 which faces a side of the first prism sheet 161 opposite to the light guiding plate 13, and a light scattering plate 163 which faces a side of the second prism sheet 162 on the opposite side of the light guiding plate 13. In addition, on the side of the optical sheet 16 opposite to the light guiding plate 13, a rectangular frame-shaped light shielding sheet 17 is disposed in the periphery of the optical sheet 16. The light shielding sheet 17 prevents a leakage of the position detecting light L2a to L2d emitted from the position detecting light sources 12A to 12D.

### Configuration of Image Creating Device 200

The image creating device 200 includes an electric optical panel 20 which is disposed on one side of the optical sheet 16 (the first prism sheet 161, the second prism sheet 162, and the light scattering plate 163) opposite to the other side where the light guiding plate 13 is provided. In the embodiment, the electric optical panel 20 is a transmissive liquid crystal panel, and has a structure in which two sheets of transmissive substrates 21 and 22 are bonded to each other through a sealing material 23 and a liquid crystal 24 is filled between the substrates. In the embodiment, the electric optical panel 20 is an active matrix type liquid panel, one of two sheets of the transmissive substrates 21 and 22 is provided with a transmissive pixel electrode, a data line, a scanning line, and a pixel switching transistor (not shown), and then the other thereof is provided with a transmissive common electrode (not shown). In addition, the pixel electrode and the common electrode may be formed on the same substrate. In the electric optical panel 20, when a scanning signal is output to each pixel through the scanning line, and an image signal is output from a data line, the alignment of the liquid crystal 24 of each of plural pixels is controlled, and hence an image is formed on the image display region 20R.

In the electric optical panel 20, the transmissive substrate 21 on one side is provided with a substrate protrusion portion 21t which protrudes more than the periphery of the external shape of the transmissive substrate 22 on the other side. Electronic components 25 constituting a driving circuit or the like are mounted onto the surface of the substrate protrusion portion 21t. In addition, the substrate protrusion portion 21t is connected to a wiring member 26 such as a flexible wiring substrate (FPC). In addition, only the wiring member 26 may be mounted onto the substrate protrusion portion 21t. If necessary, polarization plates (not shown) are disposed on the outer surfaces of the transmissive substrates 21 and 22.

Here, in order to detect the planar position of the target object Ob, it is necessary to emit the position detecting light L2a to L2d to the visible side on which the operation is performed by using the target object Ob, and the electric optical panel 20 is disposed closer to the visible side (operation side) than the light guiding plate 13 and the optical sheet 16. Accordingly, in the electric optical panel 20, the image display region 20R is formed so as to transmit the position detecting light L2a to L2d therethrough. In addition, in the case where the electric optical panel 20 is disposed on the opposite side of the visible side of the light guiding plate 13, the image display region 20R may not be configured so as to transmit the position detecting light L2a to L2d therethrough, but instead the image display region 20R needs to be configured so as to be visible from the visible side through the light guiding plate 13.

The image creating device 200 includes an illumination device 40 which illuminates the electric optical panel 20. In the embodiment, the illumination device 40 is disposed on one side of the light guiding plate 13 opposite to the other side where the electric optical panel 20 is disposed so as to be located between the light guiding plate 13 and the reflection plate 14.

The illumination device 40 includes illumination light sources 41 and an illumination light guiding plate 43 which propagates and emits illumination light emitted from the illumination light source 41, and the illumination light guiding plate 43 has a rectangular planar shape. Each of the illumination light sources 41 includes, for example, a light emitting element such as an LED (light emitting diode), and emits, for example, white illumination light L4 in response to a driving signal output from a driving circuit (not shown). In the embodiment, a plurality of illumination light sources 41 is disposed along a side portion 43a of the illumination light guiding plate 43.

As shown in FIG. 2A, the illumination light guiding plate 43 has an inclined surface 43g which is formed on a surface portion (the outer peripheral portion on the side of the side portion 43a of the light emitting surface 43s) on the side of the light emitting side adjacent to the side portion 43a, and the illumination light guiding plate 43 is gradually thickened toward the side portion 43a. With the light incident structure having the inclined surface 43g, the height of the side portion 43a is made to correspond to the height of the light emitting surface of the illumination light source 41 while suppressing an increase in thickness of the portion provided with the light emitting surface 43s.

In the illumination device 40, the illumination light emitted from the illumination light source 41 is incident to the illumination light guiding plate 43 from the side portion 43a of the illumination light guiding plate 43, is propagated therein toward an outer edge portion 43b, and then is emitted from the light emitting surface 43s as one surface. Here, the illumination light guiding plate 43 has a light guiding structure which has a monotonous ratio between a light amount of the light emitted from the light emitting surface 43s and the light propagated therein from the side portion 43a to the opposite outer edge portion 43b. For example, the light guiding structure is realized by gradually increasing an area of a refraction surface having a light deflecting or light scattering minute unevenness shape and formed on the rear surface 43t or the light emitting surface 43s of the illumination light guiding plate 43, a formation density of a printed scattering layer, or the like in the internal propagation direction. Since the light guiding structure is provided, the illumination light L4 entering from the side portion 43a is almost uniformly emitted from the light emitting surface 43s.

In the embodiment, the illumination light guiding plate 43 is disposed on one side of the electric optical panel 20 opposite to the other side close to the visible side so as to be overlapped with the image display region 20R of the electric optical panel 20 in plane, and serves as so-called back light. However, the illumination light guiding plate 43 may be disposed on the visible side of the electric optical panel 20 so as to serve as so-called front light. In addition, in the embodiment, the illumination light guiding plate 43 is disposed between the light guiding plate 13 and the reflection plate 14, but the illumination light guiding plate 43 may be disposed between the optical sheet 16 and the light guiding plate 13. The illumination light guiding plate 43 and the light guiding plate 13 may be configured as a common light guiding plate. In the embodiment, the optical sheet 16 is commonly used between the illumination line L4 and the position detecting light L2a to Ltd. However, an exclusive optical sheet different from the optical sheet 16 may be disposed on the light emitting side of the illumination light guiding plate 43. In this case, a light scattering plate exhibiting a sufficient light scattering effect is used in many cases for the purpose of equalizing the plane luminance of the illumination light L4 emitted from the light emitting surface 43s of the illumination light guiding plate 43, but when the position detecting light L2a to L2d emitted from the light emitting surface 13s of the position detecting light guiding plate 13 is largely scattered, the position detection is interrupted. For this reason, since it is necessary to omit the light scattering plate or to use the light scattering plate exhibiting a comparatively slight light scattering effect, it is desirable that the light scattering plate is exclusively used for the illumination light guiding plate 43. However, in the optical sheet such as the prism sheet (the first prism sheet 161 or the second prism sheet 162) having a light collecting effect, the light scattering plate may be commonly used.

### Configuration of Detection Region

As shown in FIG. 2A, a transmissive board plate 30 is disposed on the visible side (operation side) of the electric optical panel 20, and the light detector 15 is disposed on the outer surface (the surface opposite to the electric optical panel 20) of the board plate 30. The light detector 15 is configured as a light receiving element such as a photodiode, and is configured to detect the intensity of the position detecting light L2a to L2d. For example, as described below, when the position detecting light L2a to L2d is infrared light, the light detector 15 is configured as a light receiving element having a sensitivity for at least infrared light.

The board plate 30 on the side of the light detector 15 is provided with a surface plate 31 (depicted by the two-dotted chain line shown in FIG. 2A) which includes a frame for holding and fixing the display device 100 with the position detecting function or a casing of an electronic apparatus mounted with the display device 100 with the position detecting function. The surface plate 31 is provided with an opening 31a which exposes the detection region 10R of the optical position detecting device 10 and the image display region 20R of the electric optical panel 20 in the board plate 30.

The detection region 10R is a planar range in which the position detecting light L2a to L2d is emitted to the visible side (operation side), and a planar range in which reflected light may occur by the target object Ob. In the embodiment, the planar shape of the detection region 10R is a rectangular shape, and has four side portions 10Ra to 10Rd. The side portions 10Ra and 10Rb are short sides, and the side portions 10Rc and 10Rd are long sides. The inner angle of the corner portions 10Re to 10Rh between the adjacent sides is set to 90°, and the inner angle is set co be identical to each inner angle of the corner portions 13e to 13h of the light guiding plate 13. However, since the inner angles of the corner portions 10Re to 10Rh are specified by the corner portion of the opening 31a of the surface plate 31, the inner angle may be set independently from the inner angles of the corner portions 13e to 13h of the light guiding plate 13.

In the embodiment, although the detection region 10R is specified by the opening 31a of the surface plate 31, the configuration is not particularly limited if the range permits the position detecting light to be emitted to the visible side (operation side). That is, a configuration specified by the light emitting surface 13s of the light guiding plate 13, a configuration specified by the transmissive region of the position detecting light of the electric optical panel 20, a configuration specified by the light shielding member, and the like may be exemplified. In addition, the board plate 30 or the surface plate 31 may not be provided. For example, a structure may be adopted in which the electric optical panel 20 is directly exposed without providing the board plate 30.

In the embodiment, the image display region 20R of the electric optical panel 20 is a planar range in which a display image is displayed in the electric optical panel 20. In the embodiment, the image display region 20R is a rectangular shape having four sides, and has the same shape as that of the detection region 10R, so that the position perfectly matches with the detection region 10R in plane. However, at least a part of the detection region 10R and the image display region 20R may be overlapped with each other in plane.

The light detector 15 is attached to an opening edge 31b of the surface plate 31, and the light receiving portion 15a is fixed so as to have a posture facing the detection region 10R. The light receiving portion 15a is exposed to an edge end surface facing the opening 31a on the side of the detection region 10R in the opening edge 31b. In the embodiment, the light detector 15 is overlapped with the opening edge 31b in plane, and is coated from the visible side (operation side). Accordingly, it is possible to reduce a limitation in the exterior design.

### Principle of Detection

A method of obtaining position information of the target object Ob will be described on the basis of the detection of the light detector 15. As the method of obtaining the position information, various methods may be supposed, but for example, as one example, a method may be exemplified which obtains a coordinate position in a direction of connecting two corresponding light sources in such a manner that an attenuation coefficient ratio is obtained on the basis of a detected light amount ratio of two position detecting light, and a propagation distance of both position detecting light is obtained from the attenuation coefficient ratio.

Hereinafter, a case will be mainly described in which the position detecting light sources 12A and 12B are respectively used as the first and second position detecting light sources, and the position detecting light L2a and L2b is respectively used as the first and second position detecting light.

In the display device 100 with the position detecting function according to the embodiment, the position detecting light L2a to L2d emitted from the position detecting light sources 12A to 12D is respectively incident to the inside of the light guiding plate 13 from the light incident portions 13a to 13d, and is gradually emitted from the light emitting surface 13s while being propagated into the light guiding plate 13. As a result, the position detecting light L2a to L2d is emitted from the light emitting surface 13s in a surface shape.

For example, the position detecting light L2a is gradually emitted from the light emitting surface 13s while being propagated into the light guiding plate 13 from the light incident portion 13a toward the light incident portion 13b. In addition, the position detecting light L2b is gradually emitted from the light emitting surface 13s while being propagated into the light guiding plate 13 from the light incident portion 13b toward the light incident portion 13a.

In addition, the position detecting light L2a to L2d passes through the optical sheet 16 and the electric optical panel 20 and is emitted from the entire detection region 10R toward the visible side (operation side) of the board plate 30. Accordingly, when the target object Ob such as a finger is disposed on the visible side (operation side) of the board plate 30, the position detecting light L2a to L2d is reflected by the target object Ob, and a part of the reflected light is detected by the light detector 15.

At this time, as shown in FIG. 2B, each of the position detecting light L2a and L2b emitted from the position detecting light sources 12A and 12B travels forward while being emitted from the light emitting surface 13s.

For this reason, the light amount of the position detecting light L2a emitted to the detection region 10R is attenuated as depicted by the solid line in FIG. 2B in accordance with a distance from the position detecting light source 12A, and the light amount of the position detecting light L2b emitted to the detection region 10R is attenuated as depicted by the dotted line in FIG. 2B while having a positive correlation with respect to the distance from the position detecting light 12B.

Here, when a control amount (for example, a current amount), a conversion coefficient, and an emitted light amount of the first position detecting light source 12A are denoted by Ia, k, and Ea, and a control amount (for example, a current amount), a conversion coefficient, and an emitted light amount of the second position detecting light source 12B are denoted by Ib, k, and Eb, Ea=k·Ia and Eb=k·Ib.

In addition, when an attenuation coefficient and a detected light amount of the first position detecting light L2a are denoted by fa and Ga, and an attenuation coefficient and a detected light amount of the second position detecting light L2b are denoted by fb and Gb, Ga=fa·Ea=fa·k·Ia and Gb=fb ·Eb=fb·k·Ib.

Accordingly, when the light detector 15 is able to detect a ratio Ga/Gb of a detected light amount of both position detecting light, Ga/Gb=(fa·Ea)/(fb·Eb)=(fa/fb)·(Ia/Ib). For this reason, when values corresponding to a ratio Ea/Eb of the emitted light amount and a ratio Ia/Ib of the control amount are obtained, a ratio fa/fb of the attenuation coefficient may be obtained. Since there is a positive correlation between the attenuation coefficient ratio and the propagation distance ratio of both position detecting light, when the correlation is set in advance, it is possible to obtain the position information of the target object Ob (a position coordinate in a direction from the first position detecting light source toward the second position detecting light source).

As a method of obtaining the attenuation coefficient ratio fa/fb, for example, the first position detecting light source 12A and the second position detecting light source 12B are flickered in a reverse phase (for example, a driving signal of a rectangular waveform or a sine waveform is operated as a frequency capable of ignoring a phase difference caused by a difference in propagation distance so as to have a phase difference of 180°), and then the waveform of the detected light amount is analyzed. In more detail, for example, one control amount Ia is fixed (Ia=Im), the other control amount Ib is controlled so that the detected waveform is not observed, that is, the detected light amount ratio Ga/Gb is equal to 1, and then the attenuation coefficient ratio fa/fb is derived from the control amount Ib=Im·fa/fb) at this time.

In addition, the control may be performed so that the sum of both control amounts is normally constant, that is, Im=Ia+Ib is satisfied. In this case, since Ib=Im·fb/(fa+fb) is obtained, when fb/(fa+fb)=α, the attenuation coefficient ratio is obtained by fa/fb=(1−α)/α.

In the embodiment, the position information in the direction depicted by the arrow A of the target object Ob is obtained by driving the first position detecting light source 12A and the second position detecting light source 12B in the reverse phase. In addition, the position information in the direction depicted by the arrow B of the target object Ob is obtained by driving the first position detecting light source 12C and the second position detecting light source 12D in the reverse phase. Accordingly, it is possible to obtain the position coordinate of, the target object Ob in plane by sequentially performing the detection operation in the directions depicted by the arrows A and B in the control system.

In addition, it is possible to obtain the position coordinate of the target object Ob in plane in such a manner that the case in which the position detecting light sources 12A and 12C used as the first position detecting light source are driven in the same phase, the position detecting light sources 12B and 12D used as the second position detecting light source are driven in the same phase, and the first and second position detecting light sources are driven in the reverse phase so as to perform the detection is changed to the case in which the position detecting light sources 12A and 12D used as the first position detecting light source are driven in the same phase, the position detecting light sources 12B and 12C used as the second position detecting light source are driven in the same phase, and the first and second position detecting light sources are driven in the reverse phase so as to perform the detection, and the coordinate is sequentially obtained. According to the configuration in which the plural position detecting light sources are turned on, for example, the emitted light amount distribution (a contrast inclination distribution of the position detecting light) in the direction from the first position detecting light source toward the opposite second position detecting light source or the reverse direction thereof is suitably obtained in the range wider than that of the case of turning on one position detecting light source, thereby performing more accurate position detection.

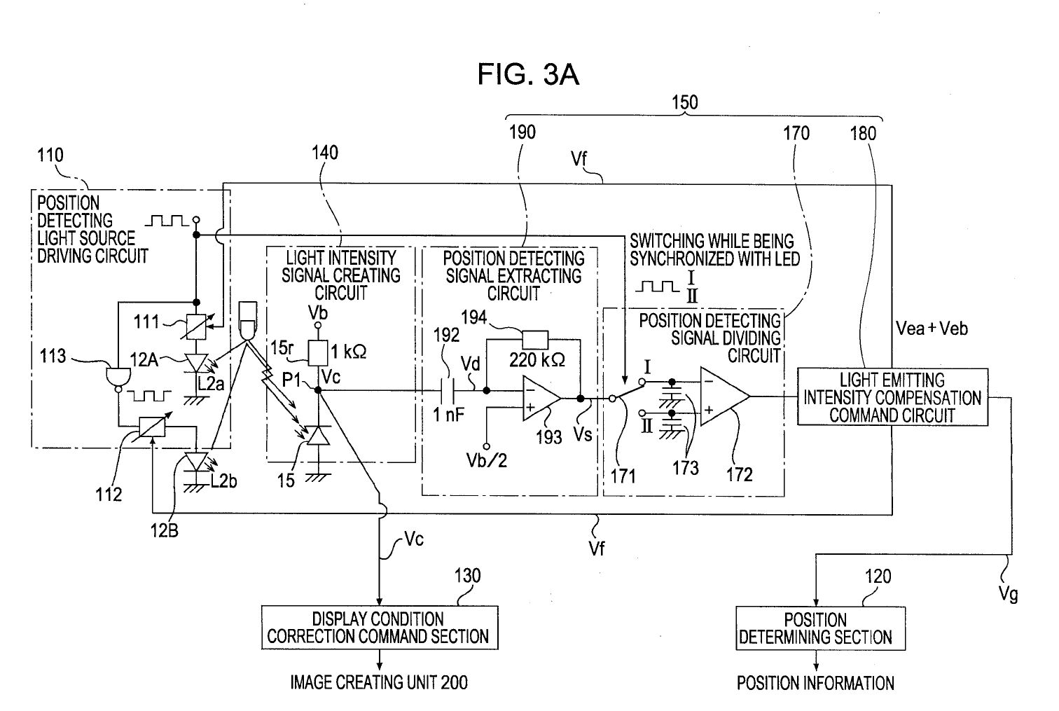

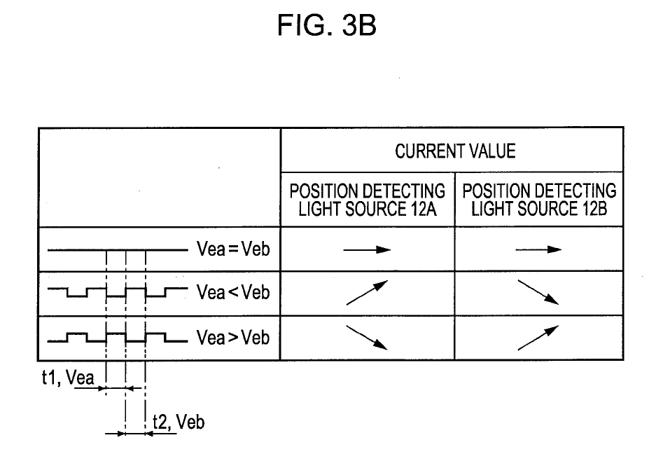

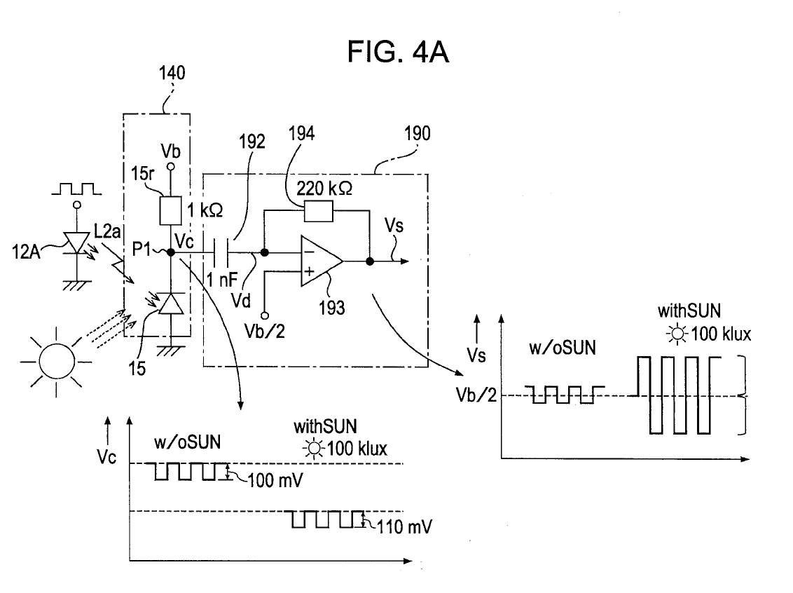

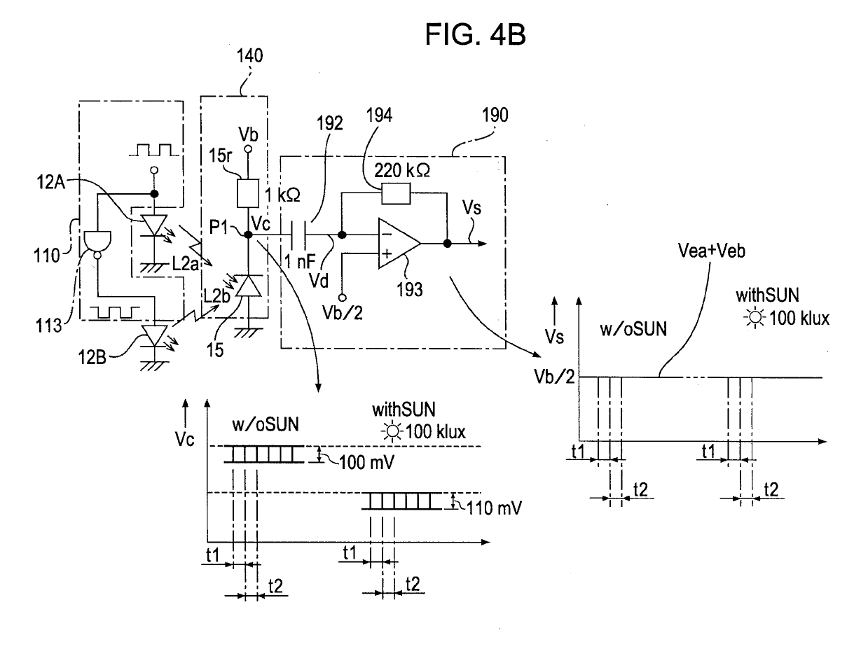

As described above, when the planar position information within the detection region 10R of the target object Ob is obtained on the basis of the light amount ratio of the first and second position detecting light detected by the light detector 15, for example, a configuration may be adopted in which a microprocessor unit (MPU) is used as a signal processing unit, and a process is performed in accordance with the execution of a predetermined software program (operation program). In addition, as described below by referring to FIGS. 3A, 3B, 4A and 4B, a configuration may be adopted in which a process of the signal processing unit is performed by using hardware such as a logic circuit. Such a signal processing unit may be assembled as a part of the display device 100 with the position detecting function, or may be provided inside of an electronic apparatus mounted with the display device 100 with the position detecting function.

In addition, as the method of obtaining the position information, in addition to the method based on the light amount ratio of the first and second position detecting light corresponding to the propagation distance inside the light guiding plate 13, for example, a method based on a phase difference of the first and second position detecting light corresponding to the propagation distance may be supposed. In this case, the planar position information of the target object Ob is calculated in accordance with a relationship between a degree of the phase difference and a difference in propagation distance.

### Influence of Environment Light

In the case where the above-described detecting method is adopted, when environment light is incident to the light detector 15, since the environment light is applied to the position detecting light L2a to L2d, as shown in FIG. 2C, a relationship between the distance from the position detecting light sources 12A and 12B and the light amount of the position detecting light L2a and L2b emitted to the detection region 10R is deviated from the relationship shown in FIG. 2B, thereby deteriorating the detection precision. Here, when the wavelength range which can be detected by the light detector 15 is limited to the infrared light range, it is possible to prevent an influence of light of a fluorescent lamp or the like not including light of the infrared light range, but it is not possible to prevent an influence of solar light.

Therefore, in the embodiment, the influence of the environment light is canceled by forming a signal processing unit as described below by referring to FIGS. 3A, 3B, 4A, and 4B. In addition, in the embodiment, since the influence of the environment light is completely canceled by the signal processing unit, the wavelength range which can be detected by the light detector 15 is set to the infrared light range and the visible light range. Accordingly, as described below, it is possible to detect the light intensity of the environment light by using the light detector 15.

### Configuration Example of Signal Processing Unit

FIG. 3A is an explanatory diagram of a signal processing unit of the display device 100 with the position detecting function and the optical position detecting device 10 according to the invention, and FIG. 3B is an explanatory diagram illustrating process contents of a light emitting intensity compensation command section of the signal processing unit. FIGS. 4A and 4B are explanatory diagrams illustrating a signal change when the environment light is incident to the light detector 15 in the display device 100 with the position detecting function and the optical position detecting device 10 according to the invention, where the case without the incident environment light is denoted by “w/oSUN”, and the case with the incident environment light is denoted by “withSUN”. In addition, in order to easily recognize the signal change in the case where the environment light is incident to the light detector 15, FIG. 4A shows the state where only the position detecting light source 12A of the position detecting light sources 12A to 12D is driven, and FIG. 4B shows the state where two position detecting light sources 12A and 12B are driven.

As shown in FIGS. 3A, 4A, and 4B, in the display device 100 with the position detecting function and the optical position detecting device 10 according to the embodiment, a position detecting light source driving circuit 110 applies a driving pulse to the position detecting light source 12A through a variable resistor 111, and applies a driving pulse to the position detecting light source 12B through an inverting circuit 113 and a variable resistor 112. For this reason, the position detecting light source driving circuit 110 applies a reverse-phase driving pulse to the position detecting light source 12A and the position detecting light source 12B, and modulates and emits the position detecting light L2a and L2b. Then, light obtained when the position detecting light L2a and L2b is reflected by the target object Ob is received by the common light detector 15. In a light intensity signal creating circuit 140, a resistor 15r of about 1 kΩ is electrically connected in serial to the light detector 15, and a bias voltage Vb is applied to both ends thereof.

In the light intensity signal creating circuit 140, the signal processing unit 150 is electrically connected to a connection point P1 between the light detector 15 and the resistor 15r. A detecting signal Vc output from the connection point P1 between the light detector 15 and the resistor 15r is expressed by Vc=V15/(V15+the resistance value of the resistor 15r), where V15: the equivalent resistance of the light detector 15. Accordingly, as shown in FIGS. 4A and 4B, when the case where the environment light is not incident to the light detector 15 is compared with the case where the environment light is incident to the light detector 15, in the case where the environment light is incident to the light detector 15, the level of the detecting signal Vc becomes low and the amplitude thereof becomes large.

The signal processing unit 150 mainly includes a position detecting signal extracting circuit 190, a position detecting signal dividing circuit 170, and a light emitting intensity compensation command circuit 180.

The position detecting signal extracting circuit 190 includes a filter 192 configured as a capacitor of about 1 nF, and the filter 192 serves as a high-pass filter which removes a direct current component from the signal output from the connection point P1 between the light detector 15 and the resistor 15r. For this reason, by using the filter 192, a position detecting signal Vd of the position detecting light L2a and L2b using the light detector 15 is extracted from the detecting signal Vc output from the connection point P1 between the light detector 15 and the resistor 15r. That is, the position detecting light L2a and L2b is modulated, but the intensity of the environment light is constant in any period. Accordingly, a low frequency component or a direct current component caused by the environment light is removed by the filter 192.

In addition, the position detecting signal extracting circuit 190 includes an adding circuit 193 having a feedback resistor 194 of about 220 kΩ at the rear stage of the filter 192. The position detecting signal Vd extracted by the filter 192 is output to the position detecting signal dividing circuit 170 as a position detecting signal Vs overlapped with a voltage V/2 which is ½ of the bias voltage Vb.

The position detecting signal dividing circuit 170 includes a switch 171 which performs a switching operation in association with a driving pulse applied to the position detecting light source 12A, a comparator 172, and capacitors 173 which are respectively and electrically connected to input lines of the comparator 172. For this reason, when the position detecting signal Vs is input to the position detecting signal dividing circuit 170, an effective value Vea of the position detecting signal Vs during a period t1 when the position detecting light L2a is turned on and an effective value Veb of the position detecting signal Vs during a period t2 when the position detecting light L2b is turned on are alternately output from the position detecting signal dividing circuit 170 to the light intensity compensation command circuit 180.

The light emitting intensity compensation command circuit 180 compares the effective values Vea and Veb, performs the process shown in FIG. 3B, and outputs a control signal Vf to the position detecting light source driving circuit 11C so that the effective value Vea of the position detecting signal Vs during the period t1 when the position detecting light L2a is turned on and the effective value Veb of the position detecting signal Vs during the period t2 when the position detecting light L2b is turned on are set to the same level as shown in FIG. 4B. That is, the light emitting intensity compensation command circuit 180 compares the effective value Vea of the position detecting signal Vs during the period t1 when the position detecting light L2a is turned on and the effective value Veb of the position detecting signal Vs during the period t2 when the position detecting light L2b is turned on, and maintains the current driving conditions for the position detecting light sources 12A and 12B when the effective values Vea and Veb are equal to each other. On the contrary, when the effective value Vea of the position detecting signal Vs during the period t1 when the position detecting light L2a is turned on is lower than the effective value Veb of the position detecting signal Vs during the period t2 when the position detecting light L2b is turned on, the light emitting intensity compensation command circuit 180 decreases a resistance value of the variable resistor 111 so as to increase the emitted light amount of the position detecting light source 12A. In addition, when the effective value Veb of the position detecting signal Vs during the period t2 when the position detecting light L2b is turned on is lower than effective value Vea of the position detecting signal Vs during the period t1 when the position detecting light L2a is turned on, the light emitting intensity compensation command circuit 180 decreases a resistance value of the variable resistor 112 so as to increase the emitted light amount of the position detecting light source 12B.

In this manner, in the display device 100 with the position detecting function and the optical position detecting device 10, the control amounts (current amounts) of the position detecting light sources 12A and 12B is controlled by the light emitting intensity compensation command circuit 180 of the signal processing unit 150 so that the detection amounts of the position detecting light L2a and L2b by the light detector 15 are equal to each other. Accordingly, since the light emitting intensity compensation command circuit 180 has information on the control amounts of the position detecting light sources 12A and 12B in which the effective value Vea of the position detecting signal Vs during the period t1 when the position detecting light L2a is turned on and the effective value Veb of the position detecting signal Vs during the period t2 when the position detecting light L2b is turned on are set to the same level, when the information is output to a position determining section 120 as a position detecting signal Vg, the position determining section 120 is able to obtain the position information of the target object Ob in the detection region 10R.

In addition, in the embodiment, in the position detecting signal extracting circuit 190, the filter 192 extracts the position detecting signal Vd by removing a direct current component caused by the environment light from the detecting signal Vc output from the connection point P1 between the light detector 15 and the resistor 15r. For this reason, even when a component caused by the environment light is included in the detecting signal Vc output from the connection point P1 between the light detector 15 and the resistor 15r, it is possible to cancel the influence of the environment light.

Further, in the embodiment, the detecting signal Vc output from the connection point P1 between the light detector 15 and the resistor 15r includes a component caused by the environment light before the direct current component is removed by the filter 192. Therefore, in the embodiment, a display condition correction command section 130 is provided, and the detecting signal Vc output from the connection point P1 between the light detector 15 and the resistor 15r is output to the display condition correction command section 130 as an environment light intensity determining signal. As a result, the display condition correction command section 130 is able to change a display condition of the image creating device 200 by changing an image signal supplied to the data line of the electric optical panel 20 or changing a driving signal supplied to the illumination light source 41 of the illumination device 40. Accordingly, it is possible to perform a display in accordance with the intensity of the environment light such that the luminance of the image displayed by the electric optical panel 20 is set to be high under a bright environment, and the luminance of the image displayed by the electric optical panel 20 is set to be dark under a dark environment.

### Main Advantage of the Embodiment

As described above, in the display device 100 with the position detecting function and the optical position detecting device 10 according to the embodiment, by using the principle of canceling the influence of the environment light in the signal processing unit 150, the wavelength range which can be detected by the light detector 15 is set to the infrared light range and the visible light range, and the intensity of the environment light such as light of fluorescent lamp or solar light is detected by the light detector 15. For this reason, in the display device 100 with the position detecting function and the optical position detecting device 10, it is not necessary to provide a light receiving element for detecting the environment light. Accordingly, in the case where the display device 100 with the position detecting function is constituted by the combination of the optical position detecting device 10 according to the embodiment and the image creating device 200, even when a light receiving element for detecting the environment light is not provided in the image creating device 200, it is possible to control the luminance of the image formed by the image creating device 200 in association with the intensity of the environment light.

In addition, in the optical position detecting device 10 according to the embodiment, the position detecting light L2a to L2d is allowed to be incident from the light incident portions 13a to 13d of the light guiding plate 13 and to be emitted from the light emitting surface 13s of the light guiding plate 13. Accordingly, since it is not necessary to provide plural light sources or light detectors, it is possible to remarkably simplify the structure and to reduce the manufacturing cost and consumption power. Particularly, in the embodiment, since the first position detecting light source and the second position detecting light source are disposed at opposite positions with the light guiding plate 13 interposed therebetween, the first position detecting light and the second position detecting light emitted from the light sources are propagated in the reverse directions in the inside of the light guiding plate 13. Accordingly, since the magnitude relationship of the inside propagation distances of both light reflected by the target object Ob has a complementary relationship, that is, a relationship in which an increase in propagation distance of one light causes a decrease in propagation distance of the other light, it is possible to easily and highly precisely detect the position information of the target object Ob in a direction connecting both light sources.

### Other Embodiments

The optical position detecting device and the display device 100 with the position detecting function according to the invention are not limited to the above-described embodiment, but may be, of course, modified into various forms within the scope not departing from the spirit of the invention. For example, in the above-described embodiment, only one light detector 15 is provided, but other light detectors may be disposed at appropriate positions.

In the embodiment, the liquid crystal panel is used as the electric optical panel 20, but other types of electric optical panels such as an organic electroluminescence panel may be used. Even in the organic electroluminescence panel, when the luminance of the image formed in the image creating device 200 is controlled in association with the intensity of the environment light, it is possible to prevent useless power consumption and to extend the lifetime of the organic electroluminescence element.

### Mounting Example to Electronic Apparatus

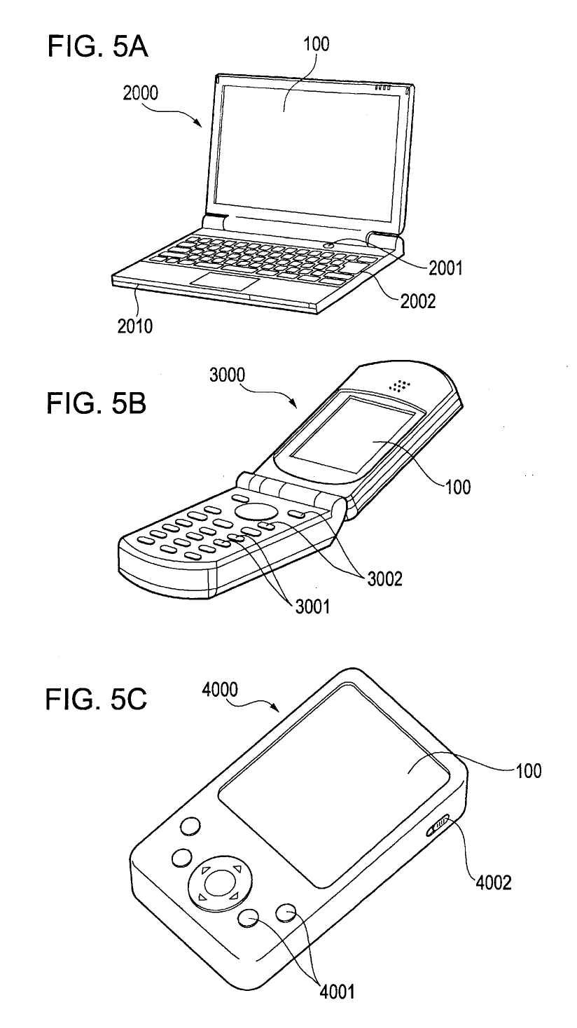

Next, an electronic apparatus adopting the display device 100 with the position detecting function according to the above-described embodiment will be described. FIG. 5A illustrates a configuration of a mobile personal computer having the display device 100 with the position detecting function. A personal computer 2000 includes the display device 100 with the position detecting function as a display unit and a main body 2010. The main body 2010 is provided with a power switch 2001 and a keyboard 2002. FIG. 5B illustrates a configuration of a cellular phone having the display device 100 with the position detecting function. A cellular phone 3000 includes plural operation buttons 3001, a scroll button 3002, and the display device 100 with the position detecting function as a display unit. When the scroll button 3002 is operated, a screen displayed on the display device 100 with the position detecting function is scrolled. FIG. 5C illustrates a configuration of a PDA (Personal Digital Assistants) adopting the display device 100 with the position detecting function. A PDA 4000 includes plural operation buttons 4001, a power switch 4002, and the display device 100 with the position detecting function as a display unit. When the power switch 4002 is operated, information such as an address list or a schedule book is displayed on the display device 100 with the position detecting function.

In addition, as the electronic apparatus adopting the display device 100 with the position detecting function, in addition to the examples shown in FIGS. 5A, 5B, and 5C, electronic apparatuses such as a digital still camera, a liquid crystal television, a viewfinder-type or a monitor-type video tape recorder, a car navigation device, a pager, an electronic note, a calculator, a word processor, a workstation, a television telephone, a POS terminal, and a bank terminal may be exemplified. In addition, as the display units of the various electronic apparatuses, the above-described display device 100 with the position detecting function may be used.

The entire disclosure of Japanese Patent Application No. 2009-050287, field Mar. 4, 2009 is expressly incorporated by reference herein.

What is claimed is:

1. An optical position detecting device for optically detecting a position of a target object within a detection region, comprising:
a position detecting light source which emits position detecting light;
a position detecting light source driving circuit which drives the position detecting light source;
a light detector of which a light receiving portion faces the detection region; and
a signal processing unit which creates an environment light intensity determining signal corresponding to intensity of environment light within the detection region and a position detecting signal for detecting the position of the target object within the detection region on the basis of a detecting signal of the light detector.

2. The optical position detecting device according to claim 1, further comprising:
a light guiding plate which includes a light incident surface for receiving therein the position detecting light emitted from the position detecting light source and a light emitting surface for emitting the position detecting light incident from the light incident surface,
wherein the light receiving portion of the light detector faces the detection region on the side where the position detecting light is emitted from the light guiding plate.

3. The optical position detecting device according to claim 1,
wherein the light detector performs a photoelectric conversion on light of a wavelength range from an infrared light range to a visible light range.

4. The optical position detecting device according to claim 1,
wherein the signal processing unit includes a position detecting signal extracting section which extracts the position detecting signal from a detection result of the light detector, and
wherein the signal processing unit uses a detecting signal of the light detector, obtained before the position detecting signal is extracted by the position detecting signal extracting section, as the environment light intensity determining signal.

5. The optical position detecting device according to claim 1,
wherein a first position detecting light source emitting first position detecting light and a second position detecting light source emitting second position detecting light are provided as the position detecting light source.

6. The optical position detecting device according to claim 5,
wherein the position detecting light source driving circuit drives the first position detecting light source and the second position detecting light source so as to have a reverse phase, and
wherein the signal processing unit includes a light emitting intensity compensation command section which controls light emitting intensity of one of the first position detecting light source and the second position detecting light source so that light receiving intensity of the light detector for the first position detecting light is equal to light receiving intensity of the light detector for the second position detecting light.

7. The optical position detecting device according to claim 5,
wherein the position detecting light source includes two pairs of light sources each having the first position detecting light source and the second position detecting light source, and
wherein light emitting surfaces for emitting the position detecting light of each pair of light sources are disposed so as to face each other.

8. A display device with a position detecting function, comprising:
the optical position detecting device according to claim 1; and
an image creating device which includes an electric optical panel disposed to face the light guiding plate,
wherein the position detecting region overlaps with an image display region of the image creating device in plane.

9. The display device with the position detecting function according to claim 8, further comprising:
a display condition correction command section which changes a display condition of the image creating device in association with intensity of environment light on the basis of the environment light intensity determining signal.

10. An electronic apparatus comprising:
the display device with the position detecting function according to claim 8.
